(19) United States
(12) Patent Application Publication
(10) Pub. No.: US 2025/0243387 A1
(43) Pub. Date: Jul. 31, 2025

(54) NON-SILICONE AND NON-FLUORINE RELEASE COATING COMPRISING POLYMER BINDERS AND MICRO BEADS

(71) Applicant: Avery Dennison Corporation, Mentor, OH (US)

(72) Inventor: Xuehua CHEN, Shanghai (CN)

(21) Appl. No.: 19/111,148

(22) PCT Filed: Oct. 10, 2023
(86) PCT No.: PCT/CN2023/123734

§ 371 Date: Mar. 12, 2025

Related U.S. Application Data
(60) Provisional application No. 63/380,296, filed on Oct. 20, 2022.

(30) Foreign Application Priority Data
Oct. 12, 2022 (CN) 202211246883.5

(51) Int. Cl. C09J 7/40; C09J 7/20; C09J 7/38

(52) U.S. Cl. CPC C09J 7/401; C09J 7/201; C09J 7/38; C09J 7/405; C09J 2203/334; C09J 2301/302; C09J 2301/412

(57) ABSTRACT

Provided here is a release coating composition, comprising of at least one polymer binder and one or more micro-beads, wherein the amount of the micro-beads is in the range of 1 vol % to 85 vol % of the total dry volume of the release coating composition. The release coating composition enables recycling of release liner substrates provides high quality printing and utilizable in self-wound label laminate construction with no liner.

### CROSS-REFERENCE TO RELATED APPLICATIONS

The present application claims the benefit of Chinese Patent Application No. 202211246883.5 filed Oct. 12, 2022 and U.S. Provisional Patent Application No. 63/380,296 filed Oct. 20, 2022, both of which are incorporated herein by reference in their entireties.

### FIELD OF THE INVENTION

The present subject matter relates generally to release coating compositions. In particular the present subject matter relates to a silicone-free, fluorine-free release coating composition. This subject matter also relates to a release coating composition that is suitable for recycling and printing, and is utilizable in self-wound label laminate construction involving no liner.

### BACKGROUND OF THE INVENTION

Generally, the release coating compositions are applied to surfaces such as paper, plastic and other films to produce a non-stick surface or enable mounting sticky material such as adhesive coating by providing a protective covering. The non-stick surface provided by these coatings allows adhesives and other sticky materials to be released and separated easily when the adhesive layer is intended to be exposed for adherence to a given substrate. Furthermore, release coatings are primarily used in the manufacture of backing materials for label laminates, tapes, decals and graphics construction but their usefulness extends to any application where unintentional adhesion is to be avoided. In pressure sensitive labels, tapes, decals and graphics applications, release coatings allow for the pressure sensitive adhesives to be easily released from the backing material without affecting the performance of the adhesive. Materials commonly used for release coatings are silicone compounds, fluorinated or partly fluorinated compounds, polymer based compositions, and wax compositions. Silicone containing release coatings are highly popular and ubiquitous in the industry because of its superior release performance.

Despite the performance, silicone containing release coatings are costly due to usage of expensive raw materials. Also silicone coatings require a dedicated coating line and additional processing step during the manufacturing process. Further, silicone release coatings also cause contamination of the adhesive layer after adhesive is laminated onto release coating owing to the spread of silicone residues, and thereby adversely affecting the adhesive properties. The leftover residual silicone during the separation process causes a variety of problems in the repulping process or recycling of the silicone carrying liners. As a result, vast quantities of label backing produced every year are destined for landfills, and makes the recycling complex or downgrade its reuse.

Non-silicone release agents are also used in a process for producing precision electronic devices like hard disk drives, ceramic capacitors, semiconductor devices, etc. The non-silicone release agent prevents the silicone deposits from contaminating the electronic components, thus reducing the potential defects in the electronic devices. But none of the non-silicone release agents used have been able to replicate the performance needed for a robust release coating to improve its shortcomings.

Release coatings based on fluoro-chemicals, fluorinated or partly fluorinated compounds are also costly. Moreover, these coatings based on fluorine chemistries are usually available in solvent form and these chemistries have potential environmental risks. Release coatings based on polymers such as polypropylene, polyethylene, polyesters, polyurethanes, various copolymers and combinations thereof have also been used. However, many of these materials have higher release force than what is required in many release performance needs. Moreover, none of the silicone, fluoro-chemicals, polymers or its combinations and wax based release coating can be printed since they inherently have low surface energy. Thus, such coating surfaces are hard to be wetted by ink, or even if printed, the ink adhesion is poor and thus results in low quality print.

In view of the above-identified challenges, there remains a need for alternative release coatings which are environmentally friendly, good adhesion coating performance, recyclable, high print quality and also exhibit excellent stable release properties.

### SUMMARY OF THE INVENTION

In one aspect of the present invention, a release coating composition is provided. More particularly, the release coating composition described herein relates to a silicone-free, fluorine-free release coating composition. Advantageously, the release coating composition is recyclable as well as printable with any suitable methods.

The silicone-free and fluorine-free release coating composition comprises at least one polymer binder and one or more micro-beads, wherein the amount of the micro-beads is in the range of 1 vol % to 85 vol % of the total dry volume of the release coating composition. In some embodiments, the ratio of the amount of micro-beads to the amount of polymer binder (v/v) is in the range of 1:0.1 to 1:60.

In some embodiments, the polymer binder includes at least one polymer selected from the group consisting of polyvinyl pyrrolidone, polyurethane, poly-acrylate, sulfonated polyester, modified polyolefin, polyvinyl alcohol, and combinations thereof.

In other embodiments, the polymer binder includes a first polymer and a second polymer, wherein the first polymer is polyvinyl pyrrolidone and the second polymer is at least one polymer selected from the group consisting of polyurethane, poly-acrylate, sulfonated polyester, modified polyolefin, polyvinyl alcohol, and combinations thereof. The ratio of the amount of the first polymer to the amount of the second polymer in the polymer binder (wt/wt) is in the range of 95:5 to 5:95.

In accordance with embodiments of the present invention, micro-beads include one of glass beads, glass bubbles, aluminum oxide particles, aluminum hydroxide particles and polymer beads including, but not limited to poly (methyl methacrylate) beads, polystyrene beads, or poly (butyl methacrylate) beads, having average particle size in the range from 5 μm to 100 μm.

In some embodiments, the silicone-free, fluorine-free release coating composition further comprises at least one additive selected from the group consisting of deforming agents, rheology adjusting agents, dispersing agents, pH adjusting agents, antimicrobial agents, anti-static agents, and cross-linkers.

In another aspect of the present invention, a release liner is provided comprising a substrate having a first side and a second side; and a release coating composition coated on at least one of the first side and the second side of the substrate, wherein the release coating composition comprises at least one polymer binder and one or more micro-beads, wherein the amount of the micro-beads is in the range of 1 vol % to 85 vol % of the total dry volume of the release coating composition.

In still another aspect of the present invention, a laminate is provided comprising a facestock having a first side and a second side; a pressure sensitive adhesive disposed on the first side of the facestock; optionally, a release liner coated on at least one of the adhesive disposed on the facestock and a release coating composition coated on at least one of the second side of the facestock or the adhesive covering side of the release liner, wherein the release coating composition is silicone-free and fluorine-free and comprises at least one polymer binder and one or more micro-beads, wherein the amount of the micro-beads is in the range of 1 vol % to 85 vol % of the total dry volume of the release coating composition.

In some embodiments, the laminate comprises a facestock having a first side and a second side; a pressure sensitive adhesive disposed on the first side of the facestock; a release liner at least partially covering the adhesive disposed on the facestock; and a release coating composition coated on the adhesive covering side of the release liner. In other embodiments, the laminate comprises a facestock having a first side and a second side; a pressure sensitive adhesive disposed on the first side of the facestock; and a release coating composition coated on the second side of the facestock.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### DETAILED DESCRIPTION OF THE INVENTION

Various embodiments and features or advantageous details are explained with reference to non-limiting embodiments that are illustrated or described in the description. Descriptions of well-known components and processing techniques are omitted so as to not unnecessarily obscure the embodiments described herein. The examples provided herein are intended merely to facilitate an understanding of ways in which the embodiments herein may be practiced or utilized. The description should not be construed as limiting the scope of the embodiments herein.

In one aspect, the present subject matter envisages a release coating composition free of silicone and fluorine. The release coating composition of the present invention is coated on substrates including facestock for self-wound laminate construction involving a coated adhesive such as pressure sensitive adhesive and with no liner, providing excellent release properties. Additionally, the release coating of the present invention is designed in such a way that it is recyclable and is also printable utilizing some of the common printing methods as known in the industry, particularly in the label industry.

As used herein, the phrase “silicone-free” or “free of silicone” means a composition having less than about 0.5% by weight silicone, based on the total weight of the dry composition, preferably less than about 0.1% by weight silicone, based on the total weight of the dry composition, more preferably less than about 0.01% by weight silicone, based on the total weight of the dry composition, and most preferably about 0% by weight silicone, based on the total weight of the dry composition. As used herein, the phrase “fluorine-free” or “free of fluorine” means a composition having less than about 0.5% by weight fluorine, based on the total weight of the dry composition, preferably less than about 0.1% by weight fluorine, based on the total weight of the dry composition, more preferably less than about 0.01% by weight fluorine, based on the total weight of the dry composition, and most preferably about 0% by weight fluorine, based on the total weight of the dry composition.

According to one embodiment of the present invention, the silicone-free, fluorine-free release coating composition includes at least one polymer binder; and one or more micro-beads such that the amount of the micro-beads is in the range of 1 vol % to 85 vol % of the total dry volume of the release coating composition. Typically, the ratio of the amount of micro-beads to the amount of polymer binder (v/v) is in the range of 1:0.1 to 1:60.

The polymer binder according to the present invention includes, but is not limited to at least one polymer selected from polyvinyl pyrrolidone, polyurethane, polyacrylate, sulfonated polyester, modified polyolefin, polyvinyl alcohol, and combinations thereof. In an exemplary embodiment, the polymer binder is polyvinyl pyrrolidone. In another exemplary embodiment, the polymer binder is polyurethane. In still another exemplary embodiment, the polymer binder is polyacrylate.

In some embodiments, the polymer binder includes a first polymer and a second polymer, wherein the first polymer is polyvinyl pyrrolidone and the second polymer is at least one polymer selected from the group consisting of polyurethane, polyacrylate, sulfonated polyester, modified polyolefin, polyvinyl alcohol, and combinations thereof. The ratio of the amount of the first polymer to the amount of the second polymer in the polymer binder (wt/wt) is in the range of 95:5 to 5:95. Preferably, the ratio of the amount of the first polymer to the amount of the second polymer in the polymer binder (wt/wt) is in the range of 90:10 to 10:90, more preferably in the range of 80:20 to 20:80. In some embodiments of the present invention, the ratio of the amount of the first polymer to the amount of the second polymer in the polymer binder (wt/wt) is 50:50.

Some polymeric binder exhibit good release performance but print quality is not good. Whereas some other polymers have good printing performance but have very high release force. The performance of the release coating composition including release force, printability, and wash performance can be tuned for desired applications by varying the proportion of the first polymer and the second polymer in the polymer binder, amount of the micro-beads and the size of the micro-bead particles.

Not bound by theory, it is observed that the polymer binder with a certain weight average molecular weight is capable of forming a coating film after the coating is dried. Very low molecular weight polymers are unable to form cohesive films due to low viscosities of these polymers. Moreover, even if films are formed the films are not stable and are prone to cracking, peeling, or breaking under stress. The polymers with high molecular weights have higher viscosities, which leads to difficulty in their processing and application. According to the present invention, the weight average molecular weight of the polymeric binder is in the range of 10,000 Da to 2000,000 Da, preferably 50,000 Da to 1000,000 Da, and further preferably 100,000 to 800,000, more preferably 400,000 Da to 600,000 Da.

In accordance with the present invention, the glass transition temperature (Tg) of the polymer binder is above the room temperature, typically 20° C. or more. If the glass transition temperature (Tg) of polymer is less than room temperature, the formed coating film becomes sticky.

The release coating composition of the present invention comprising the specific polymer binder exhibit good adhesion with the substrates (such as the facestocks used) by itself. The adhesion can be further enhanced through primer coating or through substrate surface physical treatment such as corona treatment, plasma treatment, flame treatment, etc. Adhesion strength of the release coating is tested by putting 3M 810 tape on the surface of release coating and scratching around 20 times with thumb finger. Leave it for 10 sec and then peel it off to visually observe if the coating is peeled off. If coating is peeled of then adhesion is not good, however if the coating does not peeled off then the adhesion is good.

The release coating composition of the present invention comprising the specific polymer binder have good ink anchorage and ink acceptance properties. The ink anchorage of the release coating is tested by putting the 3M 810 tape on the printed ink surface of the release coating and scratching 20 times with thumb finger. Leave it for 10 sec and then peel it off to visually observe if the ink is peeled off. If not, the anchorage is good. If ink is peeled off then ink anchorage of the release coating failed. In case of ink acceptance, one can visually observe if the ink is wetting on the surface of the release coating. If wetting is done, the ink acceptance of the release coating is good. The present invention also includes an embodiment wherein the surface of release coating is exposed to various surface treatments such as corona treatment to enhance ink acceptance.

In accordance with some embodiments, the polymer binder of the present invention includes polar groups like OH—, COOH—, —COO—NH—, SO₃—, —CO—NH—, and —CO—N—R, —Cl, —NH₂, —NH—, —COOC—, and —CO—O—CO— on the polymer structure. Presence of polar group in polymeric structure imparts polarity to the release coating, because of which the release coating can dissolve into water or hot water or caustic water under certain conditions. The polar nature of the polymer binder improves the wash off performance of the release coating composition.

The micro-beads include, but are not limited to at least one of glass beads, glass bubbles, aluminum oxide particles, aluminum hydroxide particles and polymer beads such as poly(methyl methacrylate) beads, polystyrene beads, poly(butyl methacrylate) beads. In one embodiment of the present invention, the micro-beads are glass bubbles. In another embodiment of the present invention, the micro-beads are glass beads. In still another embodiment of the present invention, the micro-beads are polymer beads.

In accordance with the embodiments of the present invention, the amount of the micro-beads is in the range of 1 vol % to 85 vol % of the total dry volume of the release coating composition. The volume percentage is calculated according to the following formula:

$$( {W}_{beads} / Density of beads ) / ( ( {W}_{beads} / Density of beads ) + ( {W}_{polymer} / Density of polymer ) ) * 100 \%$$

$$Wherein , {W}_{beads} is beads weight , {W}_{polymer} is polymer weight .$$

In terms of upper limits, the amount of the micro-beads cannot be greater than 90 vol % as total dry volume of the release coating composition. Above 90 vol %, the coating solution become paste like, which affects the coating quality and decrease the coating anchorage on the substrates or facestocks. In terms of upper limits, the amount of the micro-beads is less than 85 vol %, or less than 80 vol %, or less than 70 vol %, or less than 60 vol %, or less than 50 vol % of the total dry volume of the release coating composition. The amount of the micro-beads should be sufficient to maintain the adhesive release force not greater than 1000 g/2 inch. In the terms of lower limits, the amount of the micro-beads is at least 3 vol %, at least 7 vol %, at least 15 vol %, and at least 20 vol % of the total dry volume of the release coating composition. Preferably, the amount of the micro-beads is in the range of 5 vol % to 70 vol %, more preferably 10 vol % to 50 vol %.

In accordance with the embodiments of the present invention, the micro-beads have average particle size (D50) in the range of 5 μm to 100 μm. D50 is the corresponding particle size when the cumulative percentage reaches 50%. D50 is also called median particle diameter or median particle size. For example, for a powder sample with D50=5 μm, it means 50% of particles are larger than 5 μm and 50% particles are smaller than 5 μm.

In terms of upper limits, the average particle size can be less than 90 μm, less than 70 μm, less than 60 μm or less than 50 μm. Considering the adhesive thickness for label, tape, graphics and decals application, the average particle size is more than 5 μm, usually more than 10 μm, even 20 μm. Preferably the average particle size of micro-beads is in the range of 10 μm to 90 μm, more preferably 15 μm to 70 μm, and most preferably 20 μm to 50 μm.

Considering the required printing performance of the release coating composition, the micro-beads size cannot be unlimitedly large. It is found that the maximum size is lower than 70 μm, more preferably lower than 60 μm, more preferably lower than 50 μm. So the release coating composition combining polymer binder and micro-beads of the specific size leads to the release coating composition exhibiting the desired release properties along with being printable, cost effective for being free from silicone and fluorine compounds and also sustainable which are all described herein below.

Typically, release coating compositions are applied to surfaces such as paper, plastic and other films to produce a non-stick surface or enable mounting sticky material such as adhesive coating by providing a protective covering. The non-stick surface provided by these coatings allows adhesives and other sticky materials to be released and separated easily when the adhesive layer is intended to be exposed for adherence to a given substrate. It is believed that in order to get desired release performance, the selected micro-beads should have higher particle size than the thickness of the adhesive layer to which release coating is contacted. The larger the average particle size (D50) of the micro-beads over the thickness of the adhesive layer, the smaller is the release force required to separate the adhesive layer.

The average particle size of the micro-beads is selected such that the random microstructure is formed on the coating surface which can reduce the contact area between the coating surface and the adhesive layer, which is being covered by the release coating composition. Typically, the average particle size (D50) of the micro-beads is such that the ratio of particle size of micro-beads over the thickness of the adhesive layer in contact with the release coating is at least 0.9, at least 1.0, at least 1.1, at least 1.2, at least 1.3, at least 1.5, at least 2.0, at least 2.5, at least 3.0, at least 3.5 or at least 4.0. In some embodiments of the present invention, the ratio of average particle size of micro-beads (D50) to the thickness of the adhesive layer is at least 0.9. In preferred embodiments of the present invention, the ratio of average particle size of micro-beads (D50) to the thickness of the adhesive layer is in the range of 1.5 to 4.0.

In accordance with some embodiments of the present invention, the silicone-free, fluorine-free release coating composition further comprises at least one additive selected from the group consisting of deforming agents, rheology adjusting agents, dispersing agents, pH adjusting agents, antimicrobial agents, anti-static agents, and cross-linkers.

The release coating composition of the present invention is used in different applications including, but are not limited to labels and tapes, which is further differentiated into labels on paper/cardboards, labels on glass or plastic, automatic dispensing labels, linerless labels, packaging tapes, automotive tapes, masking tapes, medical tapes, and duct tapes. Each application has different requirement of a release force. Typically, for tape applications including packaging tapes, automotive tapes and duct tapes, the required release force is greater than 1000 g/2 in. Whereas for masking tapes, the release force required is little lower, typically in the range of 200-700 g/2 in. For medical applications, wherein tapes are typically attached to skin, the release force required is very low in the range of 10-500 g/2 in. For different label applications, the release force required ranges between 10-1000 g/2 in, typically, for automatic dispensing label applications, the required release force is less than 200 g/2 in.

Without being bound by theory, it is now surprisingly found that the specific combination of the high surface energy polymer binder and the micro-beads leads to a release coating composition exhibiting desired release properties required for the different applications. The release properties of the release coating composition are tuned to desired application by varying the ratio of polymer binder to micro-beads, and/or the size of micro-beads. Moreover, the release coating composition of the present invention are free from silicone and fluorine, thereby providing the cost effective and environment-friendly release coating composition.

The specific combination of high surface energy polymer binder and micro-beads having specific particle size leads to the release coating composition of the present invention, which exhibit the desired release property and is also printable. Surface energy (also known as interfacial free energy or surface free energy) quantifies the disruption of intermolecular bonds that occurs when a surface is created. The main components of the total surface energy are dispersive surface energy and the polar surface energy. Dispersive surface energy (also known as surface dispersion energy) refers to the energy associated with the van der Waals or London forces that operate specifically at the surface of a material or liquid. These forces arise due to temporary fluctuations in electron distribution within atoms and molecules, leading to the creation of temporary dipoles. Polar surface energy is the component of surface energy that results from the non-London forces or non-dispersive forces between molecules such as acid-base interactions, dipole-dipole interactions and H-bond interactions.

In accordance with the present invention, the release coating composition comprising the polymer binder and micro-beads showed increased surface dispersive energy (in one embodiment, dispersion energy is 39-41 mN/m) compared to the release coating composition comprising only polymer binder (dispersion energy is 31-34 mN/m), which leads to printable release coating composition. However, at the same time the polar surface energy of the release coating composition is reduced (in one embodiment, dispersion energy is 20-22 mN/m) compared to the release coating composition comprising only polymer binder (dispersion energy is 31-33 mN/m), which leads to desired release properties (in one embodiment, <1000 g/2 in) compared to only polymer binder (>2000 g/2 in). It is believed that since this combination still keeps higher total surface energy (in one embodiment, total surface energy is 60-63 mN/m) compared to only polymer binder (total surface energy is 62-68 mN/m), the ink printability is still good and microstructure containing surfaces helps to lower release forces providing good release properties.

In accordance with the embodiments of the present invention, the polymeric binder with specific molecular weight is capable of forming a coating film after the coating is dried. Similarly, the polymeric binder with specific glass transition temperature (Tg) can avoid the formed coating film being sticky at room temperature. The polymer binder as described in the present invention exhibit good adhesion properties along with good ink anchorage and ink acceptance properties.

The release coating composition can be applied to substrate such as on a facestock using any of the coating techniques known in the art, such as, but not limited to, bar coating, roll coating, gravure coating, multi-roll coating, reverse roll, air knife, wire wound rod, doctor blade, and the like and other coating processes.

In accordance with another aspect of the present invention, a release liner is provided. The release liner comprises a substrate having a first side and a second side; and a release coating composition comprising at least one polymer binder and one or more micro-beads, wherein the amount of the micro-beads is in the range of 1 vol % to 85 vol % of the total dry volume of the release coating composition. Typically, the substrate includes at least one selected from paper or polymeric film.

In accordance with another aspect of the present invention, a laminate is provided. The laminate comprises a facestock having a first side and a second side; a pressure sensitive adhesive disposed on the first side of the facestock; optionally a release liner at least partially covering the adhesive disposed on the facestock; and a release coating composition coated on at least one of the second side of the facestock or the adhesive covering side of the release liner. The release coating composition comprises at least one polymer binder and one or more micro-beads, wherein the amount of the micro-beads is in the range of 1 vol % to 85 vol % of the total dry volume of the release coating composition.

In accordance with one embodiment, the laminate comprises a facestock having a first side and a second side; a pressure sensitive adhesive disposed on the first side of the facestock; and a release liner at least partially covering the adhesive disposed on the facestock; wherein a release coating composition of the present invention is coated on the adhesive covering side of the release liner.

In accordance with another embodiment, the laminate comprises a facestock having a first side and a second side; and a pressure sensitive adhesive disposed on the first side of the facestock; and wherein a release coating composition of the present invention is coated on the second side of the facestock.

Typically, the facestock includes, but not limited to a monolayer material or multilayer material. The facestock is at least one substrate selected from paper or polymeric film. The polymeric film is at least one selected from the group consisting of polyester film such as a polyethylene terephthalate film (PET), polybutyleneterephthalate (PBT) film, and a polyethylenenaphthalate (PEN) film, polyethylene film (PE), polypropylene film (PP), a polyethylene-polypropylene copolymer film or blend film, polyvinyl chloride film (PVC), polyimide film (PI), polyurethane film (PU), polycarbonate film (PC), polymethylmethacrylate film (PMMA), polyamide film (PA), metalized film, acrylate resin film, acrylate-urethane copolymer film, surface coated polymeric films such as primer coated films and the like. The paper includes craft paper, mid gloss paper, vellum paper, maplitho paper, chromo paper, semi-gloss paper, high-gloss paper, foils and metallized paper, hemp paper, glassine paper, surface coated paper such as primer coated paper etc.

The pressure sensitive adhesive includes, but is not limited to a solvent based adhesive, emulsion based adhesive, hot-melt adhesive, or heat, moisture or external stimuli activated adhesive, semi-structural adhesive, structural adhesive according to one embodiment herein. Typically, the thickness of the adhesive layer coated on the facestock is in the range of 2 μm to 40 μm, preferably 5 μm to 50 μm, more preferably 8 μm to 25 μm, most preferably 10 μm to 20 μm.

The laminate of the present invention has a release force in a range from 1 g/2 inch to 1000 g/2 inch tested at 90° peel force at 300 inches/min peel speed, 2 inch width specimen and under 24 hours dwell time at room temperature.

Importantly, the inventors of the present invention have found that the release liner having release coating composition involving at least one polymer binder and at least one micro bead is recyclable under recycling process. Additionally, it also found that the release coating is printable and does not suffer from the printing problems associated with silicone containing release liners. The release coating composition is printable with multiple printing methods including UV flexographic printing, waterborne flexographic printing, UV letterpress, digital printing, UV inkjet printing, solvent borne inkjet printing, screen printing, offset printing, gravure printing, etc.

The present invention will be further described by the following non-limiting examples. Different samples of the release coating composition of the present invention comprising different polymeric binder, and micro-beads in varying particle sizes and in varying amounts (volume percentages as total dry volume) are prepared and their performance is tested in terms of release force, washability (recyclability), ink acceptance and ink anchorage.

Beads volume percentage is calculated according to the following formula:

$$( {W}_{beads} / Density of beads ) / ( ( {W}_{beads} / Density of beads ) + ( {W}_{polymer} / Density of polymer ) ) * 100 \%$$

$$Wherein , {W}_{beads} is beads weight , {W}_{polymer} is polymer weight$$

The different samples comprising different polymer binders and one of PBMA beads or glass bubbles as micro-beads were prepared and tested for release force by method as given below.

Release force test: The release coating composition was coated onto 50 μm PET film to form a release liner. In exemplary embodiment, the laminate was prepared by laminating with a 50 μm PET tape having a 22 μm acrylic adhesive SR207 (Avery Dennison) onto the release coating surface of the above prepared release liner using a 2 kg roller. The laminate obtained was tested for release force under 24 hours dwell at room temperature. Release tests were conducted using a 90° peel force at 300 inches/min peel speed and 2 inch width specimen. The obtained results of release force values (g/2 inch) obtained are tabulated in table 1 below:

TABLE 1
Release force test

| Micro Bead | | | | | |
|---|---|---|---|---|---|
| Bead Size | Polymer Binder | | | | |
| (D50) | | | Sulfonated | Maleic anhydride | |
| Vol % | Polyurethane | Polyacrylate | polyester | modified polyolefin | PVP |
| PBMA bead | 806 | 419 | 574 | 271 | 187 |
| 30 um | | | | | |
| 46% | | | | | |
| Glass Bubbles | 16 | 16 | 20 | 13 | 12 |
| 40 um | | | | | |
| 12% | | | | | |

The different samples comprising different polymer binders and glass bubbles as micro-beads were prepared and tested for wash-off performance (recyclability) by the method as given below.

Recyclability test: The recyclability of the release liner (PET as substrate) wherein release coating composition of the present invention is coated is tested by washing off the release coating composition. The hot washing fluid (Sodium Hydroxide solution) in washing bath was agitated via a magnetic stirrer at 240 rpm and the washing liquid bath was maintained at a temperature of 85° C.±1° C. for a certain time. Shorter the time required to remove the release coating composition from the substrate, the better is the washing off performance. Washing liquid may be 1-4% wt, preferably 1-2% wt alkaline water i.e. alkaline aqueous solution comprising caustic soda, such as sodium hydroxide. The obtained results of wash-off obtained are tabulated in table 2 below:

TABLE 2
Recyclability Performance

| | | | | | | Maleic acid | | |
|---|---|---|---|---|---|---|---|---|
| | Polymer | | | Poly | Sulfonated | modified | Chlorinated | |
| Formulation | binder | PVP | Polyurethane | acrylate | polyester | polyolefin | polyolefin | PVA |
| | Beads (Glass | D50 = 40 μm, glass bubbles, 11.76% volume as total dry volume | | | | | | |
| | bubbles) | | | | | | | |
| Wash off | NaOH 1% wt | ⊚ | ⊚ | Δ | Δ | Δ | ⊚ | ⊚ |
| condition | 85 C./240 rpm | | | | | | | |

x—poor performance (>1 hr);
Δ—general performance (15 min-1 hr);
□—good performance (5 min-15 min); and
⊚—best performance (<5 min)

The release coating composition comprising polyvinyl pyrrolidone as polymer binder and glass beads as micro-beads was prepared and tested for printability performance using different printing techniques.

Ink anchorage test: The ink anchorage of the release coating composition is tested by putting the 3M 810 tape on the printed ink surface of the release coating and scratching 20 times with thumb finger. Leave it for 10 sec and then peel it off to visually observe if the ink is peeled off. If not, the anchorage is good. If ink is peeled off then ink anchorage of the release coating failed.

Ink acceptance: In case of ink acceptance, one can visually observe if the ink is wetting on the surface of the release coating. If wetting is done, the ink acceptance of the release coating is good. The obtained results for ink acceptance and ink anchorage for different printing techniques are given in table 3 below:

TABLE 3
Printing Performance

| | Printing Methods | | | | | | | |
|---|---|---|---|---|---|---|---|---|
| | Without corona-treatment | | | | With corona-treatment | | | |
| | UV | | UV | | UV | | UV | |
| Release | flexo | | letterpress | | flexo | | letterpress | |
| Coating | Ink | Ink | Ink | Ink | Ink | Ink | Ink | Ink |
| Composition | acceptation | anchorage | acceptation | anchorage | acceptation | anchorage | acceptation | anchorage |
| PVP | Good | Good | Good | Good | Good | Good | Good | Good |
| 24.62 vol % | | | | | | | | |
| glass bead | | | | | | | | |
| (D50 = 40 um) | | | | | | | | |
| | Printing Methods | | | | | | | |
| | Digital | | | | | | | |
| | printing | | Inkjet | | | | Water | |
| Release | (dry toner) | | (solvent) | | UV Inkjet | | flexo | |
| Coating | Ink | Ink | Ink | Ink | Ink | Ink | Ink | Ink |
| Composition | acceptation | anchorage | acceptation | anchorage | acceptation | anchorage | acceptation | anchorage |
| PVP | Good | Good | Good | Good | Good | Good | Good | Good |
| 24.62 vol % | | | | | | | | |
| glass bead | | | | | | | | |
| (D50 = 40 um) | | | | | | | | |

Table 4a and table 4b represents effect of different polymer binder, and different micro-beads in varying particle sizes and in varying amounts (volume percentages as total dry volume) on the performance of the release coating composition of the present invention with respect to release force, recyclability (wash-off performance) and printability.

TABLE 4a
Effect of binders and micro-beads

| | | | | beads % | | | | | | |
|---|---|---|---|---|---|---|---|---|---|---|
| | | | | volume | 90 | | | | | |
| | | | | (ratio of | release | Recyclability | Printability | | | |
| | | | Size of | vol % of | force | Wash-Off | With CORONA treatment | | | |
| | | | micro- | binder to | SR207 | 1% NaOH | UV flexo | | Letter press | |
| Sr. | | Micro- | beads | vol % of | adhesive | 85° C./240 rpm | Ink | Ink | Ink | Ink |
| No. | Binder | beads | (D50) | beads) | (g/2 in) | Time | acceptance | anchorage | acceptance | anchorage |
| 1 | PVP | Glass | 40 μm | 11.76 | 12 | 1 min | Good | Good | Good | Good |
| | | Bubbles | | (7.5) | | | | | | |
| 2 | | Glass | 40 μm | 15.09 | 17 | 1 min | Good | Good | Good | Good |
| | | Beads | | (5.62) | | | | | | |
| 3 | | Polymer | 30 μm | 45.66 | 187 | 1 min | Good | Good | Good | Good |
| | | Beads | | (1.19) | | | | | | |
| 4 | Polyurethane | Glass | 40 μm | 11.76 | 16 | 1 min | Good | Fair | Good | Fair |
| | | Bubbles | | (7.5) | | | | | | |
| 5 | | Glass | 40 μm | 15.09 | 535 | 5 min | Good | Fair | Good | Fair |
| | | Beads | | (5.62) | | | | | | |
| 6 | | Polymer | 40 μm | 45.66 | 806 | 5 min | Good | Poor | Good | Poor |
| | | Beads | | (1.19) | | | | | | |
| 7 | Polyacrylate | Glass | 40 μm | 11.76 | 16 | 50 min | Good | Good | Good | Good |
| | | Bubbles | | (7.5) | | | | | | |
| 8 | | Glass | 40 μm | 15.09 | 361 | 5 min | Good | Good | Good | Good |
| | | Beads | | (5.62) | | | | | | |
| 9 | | Polymer | 30 μm | 45.66 | 419 | 5 min | Good | Good | Good | Good |
| | | Beads | | (1.19) | | | | | | |
| 10 | Sulfonated | Glass | 40 μm | 11.76 | 20 | 1 hr. | Fair | Good | Good | Good |
| | | Bubbles | | (7.5) | | | | | | |
| 11 | polyester | Glass | 40 μm | 15.09 | 229 | 1 hr | Fair | Good | Good | Good |
| | | Beads | | (5.62) | | | | | | |
| 12 | | Polymer | 30 μm | 45.66 | 574 | 1 hr | Good | Good | Good | Good |
| | | Beads | | (1.19) | | | | | | |
| 13 | maleic acid | Glass | 40 μm | 11.76 | 13 | 1 hr | Good | Fair | Good | Good |
| | | Bubbles | | (7.5) | | | | | | |
| 14 | modified | Glass | 40 μm | 15.09 | 105 | 30 min | Good | Fair | Good | Good |
| | | Beads | | (5.62) | | | | | | |
| 15 | polyolefin | Polymer | 30 μm | 45.66 | 271 | 30 min | Good | Fair | Good | Fair |
| | | Beads | | (1.19) | | | | | | |
| 16 | chlorinated | Glass | 40 μm | 11.76 | 19 | 1 min | Good | Fair | Fair | Fair |
| | | Bubbles | | (7.5) | | | | | | |
| 17 | polyolefin | Glass | 40 μm | 15.09 | peel off | 2 min | Good | Poor | Good | Poor |
| | | Beads | | (5.62) | | | | | | |
| 18 | | Polymer | 30 μm | 45.66 | Peel off | 2 min | Good | Poor | NA | NA |
| | | Beads | | (1.19) | | | | | | |
| 1 | PVP | Aluminium | 50 μm | 24.62 | 14 | 1 min | Good | Good | Good | Good |
| | | hydroxide | | | | | | | | |
| 2 | | Aluminium | 50 μm | 24.62 | 67 | 1 min | Good | Good | Good | Good |
| | | oxide | | | | | | | | |
| 3 | Polyurethane | Aluminium | 50 μm | 24.62 | 6 | 6 min | Good | Good | Good | Good |
| | | hydroxide | | | | | | | | |
| 4 | | Aluminium | 50 μm | 24.62 | 26 | 6 min | Good | Good | Good | Good |
| | | oxide | | | | | | | | |
| 5 | Polyacrylate | Aluminium | 50 μm | 24.62 | 5 | 7 min | Good | Good | Good | Good |
| | | hydroxide | | | | | | | | |
| 6 | | Aluminium | 50 μm | 24.62 | 9 | 6 min | Good | Good | Good | Good |
| | | oxide | | | | | | | | |
| 7 | Sulfonated | Aluminium | 50 μm | 24.62 | 9 | 57 min | Good | Good | Good | Good |
| | | hydroxide | | | | | | | | |
| 8 | polyester | Aluminium | 50 μm | 24.62 | 30 | 46 min | Good | Good | Good | Good |
| | | oxide | | | | | | | | |
| 9 | melaic acid | Aluminium | 50 μm | 24.62 | 6 | 38 min | Good | Good | Good | Good |
| | modified | hydroxide | | | | | | | | |
| 10 | polyolefin | Aluminium | 50 μm | 24.62 | 17 | 33 min | Good | Good | Good | Good |
| | | oxide | | | | | | | | |
| 11 | chlorinated | Aluminium | 50 μm | 24.62 | Peel off | 2 min | Good | Good | Good | Good |
| | | hydroxide | | | | | | | | |
| 12 | polyolefin | Aluminium | 50 μm | 24.62 | 16 | 6 min | Good | Good | Good | Good |
| | | oxide | | | | | | | | |

Table 5 represents effect of the combination of binder on the performance of the release coating composition.

TABLE 5
Effect of combination of binders

| | | | | 90 release | | | Printability | | | |
|---|---|---|---|---|---|---|---|---|---|---|
| | | | | force for | | | With CORONA treatment | | | |
| | | Ratio of | vol % of | SR207 | | | UV flexo | | Letter press | |
| Sr. | | polymer | glass | adhesive | Wash of | | Ink | Ink | Ink | Ink |
| No. | Binder | binder | bubbles | (g/2 in) | performance | | Acceptance | anchorage | Acceptance | anchorage |
| 1 | PVP | 100:0 | 11.76 | 12 | 1 | min | Good | Good | Good | Good |
| | | | (7.5) | | | | | | | |
| 2 | Polyurethane | 100:0 | 11.76 | 16 | 1 | min | Good | Fair | Good | Fair |
| | | | (7.5) | | | | | | | |
| 3 | Sulfonated | 100:0 | 11.76 | 20 | 1 | hr | Fair | Good | Good | Good |
| | Polyester | | (7.5) | | | | | | | |
| 4 | Maleic anhydride | 100:0 | 11.76 | 13 | 1 | hr | Good | Fair | Good | Good |
| | modified | | (7.5) | | | | | | | |
| | polyolefin | | | | | | | | | |
| 5 | Chlorinated | 100:0 | 11.76 | 19 | 1 | min | Good | Fair | Fair | Fair |
| | polyolefin | | (7.5) | | | | | | | |
| 6 | Polyacrylate | 100:0 | 11.76 | 16 | 50 | min | Good | Good | Good | Good |
| | | | (7.5) | | | | | | | |
| 7 | PVP:Polyurethane | 50:50 | 11.76 | 12 | 2 | min | Good | Good | Good | Fail |
| 8 | | 20:80 | (7.5) | 14 | 2 | min | Good | Good | Good | Fail |
| 9 | | 90:10 | 22.13 | 13 | 2 | min | Good | Good | Good | Good |
| | | | (3.5) | | | | | | | |
| 10 | PVP:Sulfonated | 50:50 | 11.76 | NA | 2 | min | NA | NA | NA | NA |
| 11 | polyester | 20:80 | (7.5) | NA | 2 | min | NA | NA | NA | NA |
| 12 | | 90:10 | 22.13 | 15 | 2 | min | Good | Good | Good | Good |
| | | | (3.5) | | | | | | | |
| 13 | PVP:Maleic | 50:50 | 11.76 | 13 | 2 | min | Good | Good | Good | Fail |
| | anhydride | | | | | | | | | |
| 14 | modified | 20:80 | (7.5) | 12 | 2 | min | Good | Good | Good | Fair |
| 15 | polyolefin | 90:10 | 22.13 | 13 | 2 | min | Good | Good | Good | Fair |
| | | | (3.5) | | | | | | | |
| 16 | PVP:Chlorinated | 50:50 | 11.76 | 15 | 2 | min | Good | Good | Fair | Good |
| 17 | polyolefin | 20:80 | (7.5) | 11 | 2 | min | Good | Good | Fair | Good |
| 18 | | 90:10 | 22.13 | 17 | 2 | min | Good | Good | Fair | Good |
| | | | (3.5) | | | | | | | |
| 19 | PVP:Polyacrylate | 50:50 | 11.76 | 17 | 2 | min | Good | Good | Good | Good |
| 20 | | 20:80 | (7.5) | 15 | 2 | min | Good | Good | Good | Good |
| 21 | | 90:10 | 22.13 | 12 | 2 | min | Good | Good | Good | Fair |
| | | | (3.5) | | | | | | | |
| 22 | PVP:PVA | 50:50 | 11.76 | 15 | 2 | min | Good | Good | Good | Fair |
| 23 | | 20:80 | (7.5) | 11 | 2 | min | Good | Good | Good | Fail |
| 24 | | 90:10 | 22.13 | 15 | 2 | min | Good | Good | Good | Good |
| | | | (3.5) | | | | | | | |

Table 6 represents the effect of particle size of micro-beads and amount of micro-beads on the performance of the release coating composition. Different samples comprising varying amounts of glass bubbles with varying particle sizes were prepared and tested for release force, wash-off performance and printability.

TABLE 6
Effect of particle size of micro-beads and amount of micro-beads

| | | | | | | Printability | | | |
|---|---|---|---|---|---|---|---|---|---|
| | | | | | | With CORONA treatment | | | |
| | Bead | bead size/ | | | | UV flexo | | Letter press | |
| Sr. | particle | adhesive | Beads | Release | Wash of | Ink | Ink | Ink | Ink |
| No. | Size | thickness | volume % | force | performance | Acceptance | anchorage | Acceptance | anchorage |
| 1 | 20 | 0.91 | 85 | 893 | 1 min | fair | Good | Good | Good |
| | | | (0.17) | | | | | | |
| 2 | | | 50 | 465 | 1 min | fair | Good | Good | Good |
| | | | (1.0) | | | | | | |
| 3 | | | 20 | 1913 | 1 min | Good | Good | Good | Good |
| | | | (4.0) | | | | | | |
| 4 | | | 10 | 2002 | 1 min | Good | Good | Good | Good |
| | | | (9.0) | | | | | | |
| 5 | | | 5 | 2479 | 1 min | Good | Good | Good | Good |
| | | | (19.0) | | | | | | |
| 6 | 30 | 1.36 | 85 | 384 | 1 min | fair | Good | Good | Good |
| | | | (0.17) | | | | | | |
| 7 | | | 50 | 170 | 1 min | fair | Good | Good | Good |
| | | | (1.0) | | | | | | |
| 8 | | | 20 | 605 | 1 min | Good | Good | Good | Good |
| | | | (4.0) | | | | | | |
| 9 | | | 10 | 2283 | 1 min | Good | Good | Good | Good |
| | | | (9.0) | | | | | | |
| 10 | | | 5 | 1913 | 1 min | Good | Good | Good | Good |
| | | | (19.0) | | | | | | |
| 11 | 40 | 1.59 | 85 | 109 | 1 min | Fair | Good | Fair | Good |
| | | | (0.17) | | | | | | |
| 12 | | | 50 | 19 | 1 min | Fair | Good | Fair | Good |
| | | | (1.0) | | | | | | |
| 13 | | | 20 | 15 | 1 min | Good | Good | Good | Good |
| | | | (4.0) | | | | | | |
| 14 | | | 10 | 12 | 1 min | Good | Good | Good | Good |
| | | | (9.0) | | | | | | |
| 15 | | | 5 | 2157 | 1 min | Good | Good | Good | Good |
| | | | (19.0) | | | | | | |
| 16 | 50 | 2.27 | 85 | 31 | 1 min | Fair | Good | Fair | Good |
| | | | (0.17) | | | | | | |
| 17 | | | 50 | 41 | 1 min | Fair | Good | Fair | Good |
| | | | (1.0) | | | | | | |
| 18 | | | 20 | 29 | 1 min | Good | Good | Good | Good |
| | | | (4.0) | | | | | | |
| 19 | | | 10 | 27 | 1 min | Good | Good | Good | Good |
| | | | (9.0) | | | | | | |
| 20 | | | 5 | 1616 | 1 min | Good | Good | Good | Good |
| | | | (19.0) | | | | | | |
| 21 | 60 | 2.72 | 85 | 75 | 1 min | Fair | Good | Fair | Good |
| | | | (0.17) | | | | | | |
| 22 | | | 50 | 41 | 1 min | Fair | Good | Fair | Good |
| | | | (1.0) | | | | | | |
| 23 | | | 20 | 24 | 1 min | Good | Good | Good | fair |
| | | | (4.0) | | | | | | |
| 24 | | | 10 | 28 | 1 min | Good | Good | Good | Good |
| | | | (9.0) | | | | | | |
| 25 | | | 5 | 1688 | 1 min | Good | Good | Good | Good |
| | | | (19.0) | | | | | | |

When the bead volume is higher than 90 vol % as the total dry volume, the coating solution exhibit paste-like consistency and leads to poor anchorage of coating composition onto the substrate or facestock. Further to maintain the release force <1000 g/2 in, for average bead size >40 μm, the bead volume should be no less than 7 vol % as total dry volume; for average bead size <40 μm, the bead volume should be more than 20 vol %, even more than 50 vol % as total dry volume. The beads size over adhesive thickness should be at least 0.9.

Table 7 represents the effect of particle size of polymer-beads and amount of polymer beads on the performance of the release coating composition. Different samples comprising varying amounts of polymer beads with varying particle sizes were prepared and tested for release force, wash-off performance and printability.

TABLE 7
Effect of polymer beads particle size and amount of polymer beads

| | | | | | | Printability | | | |
|---|---|---|---|---|---|---|---|---|---|
| | | | | | | With CORONA treatment | | | |
| | Bead | bead size/ | | | | UV flexo | | Letter press | |
| Sr. | particle | adhesive | Beads | Release | Wash of | Ink | Ink | Ink | Ink |
| No. | Size | thickness | volume % | force | performance | Acceptance | anchorage | Acceptance | anchorage |
| 1 | 20 | 0.91 | 60 | 1454 | 1 min | Good | Good | good | Good |
| | | | (0.6) | | | | | | |
| 2 | | | 50 | 1410 | 1 min | Good | Good | good | Good |
| | | | (1.0) | | | | | | |
| 3 | | | 20 | 1849 | 1 min | Good | Good | Good | poor |
| | | | (4.0) | | | | | | |
| 4 | | | 10 | 1883 | 1 min | Good | Good | Good | poor |
| | | | (9.0) | | | | | | |
| 5 | 30 | 1.36 | 60 | 287 | 1 min | Good | Good | good | Good |
| | | | (0.6) | | | | | | |
| 6 | | | 50 | 97 | 1 min | Good | Good | good | Good |
| | | | (1.0) | | | | | | |
| 7 | | | 20 | 41 | 1 min | Good | Good | Good | Good |
| | | | (4.0) | | | | | | |
| 8 | | | 10 | 23 | 1 min | fair | Good | fair | Good |
| | | | (9.0) | | | | | | |
| 9 | 50 | 2.27 | 60 | 40 | 1 min | fair | Good | fair | Good |
| | | | (0.6) | | | | | | |
| 10 | | | 50 | 49 | 1 min | Good | Good | Good | Good |
| | | | (1.0) | | | | | | |
| 11 | | | 20 | 22 | 1 min | Good | Good | Good | Good |
| | | | (4.0) | | | | | | |
| 12 | | | 10 | 18 | 1 min | fair | Good | fair | Good |
| | | | (9.0) | | | | | | |
| 13 | 70 | 2.72 | 60 | 16 | 1 min | fair | Good | fair | Good |
| | | | (0.6) | | | | | | |
| 14 | | | 50 | 15 | 1 min | fair | Good | fair | Good |
| | | | (1.0) | | | | | | |
| 15 | | | 20 | 8 | 1 min | Good | Good | Good | Good |
| | | | (4.0) | | | | | | |
| 16 | | | 10 | 6 | 1 min | Good | Good | Good | Good |
| | | | (9.0) | | | | | | |

It was observed from the table above that smaller is the contact area between the adhesive and the release surface, lower is the release force and vice-versa.

Table 8 represents the laminate without a liner (called linerless label) and which includes a facestock having a first side and a second side; a pressure sensitive adhesive disposed on the first side of the facestock; and a release coating composition coated on the second side of the facestock. The release coating composition comprising polymer binder Polyvinyl pyrrolidone (PVP) and glass bead (% volume as total dry volume), having D50=40 μm particle size were tested. The laminate by laminating the adhesive side of linerless lamination onto the release side of the linerless lamination with 2 kg roller was then tested for release under 24 hours dwell at room temperature. Release tests were conducted using a 90° peel force at 300 inches/min peel speed and 2 inch width specimen. The adhesion of adhesive was conducted using loop tack on stainless steel (SS) under 24 hours dwell at room temperature and 90° peel strength on stainless steel under 24 hours dwell at room temperature. The desired results of release force values (g/2 inch) obtained are tabulated in table 8.

TABLE 8
The performance of the laminate without a liner (linerless label)

| | release force | Loop tack on SS | 90 peel strength on SS |
|---|---|---|---|
| Linerless lamination construction | (g/2 in) | @24 hr (N/in) | @24 hr (N/in) |
| 6gsm SF release layer/50 um | 34 | 6 | 7 |
| PET facestock/ 18gsm emulsion acrylic | | | |
| adhesive | | | |
| 6gsm SF release layer/50 um PET | 10 | 12 | 11 |
| facestock/12gsm hotmelt rubber adhesive | | | |
| 6gsm SF release layer/50 um PET | 35 | 12 | 8 |
| facestock/ 15gsm solvent acrylic adhesive | | | |
| 6gsm SF release layer/60 um Primax | 117 | 13 | 9 |
| facestock/18gsm | | | |
| emulsion acrylic adhesive | | | |

Table 9 represents effect of the incorporation of micro-beads on the surface energy of polymer binder.

TABLE 9
Surface energy results of release coating surface

| | Surface energy (mN /m) | | |
|---|---|---|---|
| sample no. | Total | Dispersion | Polar |
| PVP with 26.23 vol % | 62.1 ± 1.5 | 40.2 ± 0.4 | 21.9 ± 1.1 |
| Glass beads | | | |
| D50 = 40 um | | | |
| PVP (as comparative | 65.3 ± 2.7 | 32.5 ± 1.3 | 32.8 ± 1.4 |
| example) | | | |

From table 9, it was observed that incorporation of the micro-beads into the high surface energy binder increases the dispersive surface energy of the coating and lowers the polar surface energy, without affecting the total surface energy. The resulting release coating composition is printable as well as exhibits lower release force.

1. A silicone-free release coating composition comprising: at least one polymer binder; and one or more micro-beads; wherein the amount of the micro-beads is in the range of 1 vol % to 85 vol % of the total dry volume of the release coating composition.

2. The release coating composition according to claim 1, wherein the polymer binder is at least one polymer selected from the group consisting of polyvinyl pyrrolidone, polyurethane, poly-acrylate, sulfonated polyester, modified polyolefin, polyvinyl alcohol, and combinations thereof.

3. The release coating composition according to claim 1, wherein the polymer binder comprises a first polymer and a second polymer.

4. The release coating composition according to claim 3, wherein the first polymer is polyvinyl pyrrolidone and the second polymer is selected from the group consisting of polyurethane, poly-acrylate, sulfonated polyester, modified polyolefin, polyvinyl alcohol, and combinations thereof.

5. The release coating composition according to claim 3, wherein the ratio of the amount of the first polymer and the second polymer in the polymer binder (wt/wt) is in the range of 95:5 to 5:95.

6. The release coating composition according to claim 3, wherein the ratio of the amount of the first polymer and the second polymer in the polymer binder (wt/wt) is in the range of 80:20 to 20:80.

7. The release coating composition according to claim 1, wherein the micro-beads are selected from the group consisting of glass beads, glass bubbles, polymer beads, aluminum oxide particles, aluminum hydroxide particles and combinations thereof.

8. The release coating composition according to claim 7, wherein the polymer beads are one of poly(methyl methacrylate) beads, polystyrene beads, or poly(butyl methacrylate) beads.

9. The release coating composition according to claim 1, wherein the amount of the micro-beads is in the range of 5 vol % to 70 vol % of the total dry volume of the release coating composition.

10. The release coating composition according to claim 1, wherein the amount of the micro-beads is in the range of 10 vol % to 50 vol % of the total dry volume of the release coating composition.

11. The release coating composition according to claim 1, wherein the micro-beads have an average particle size in a range from 5 μm to 100 μm.

12. The release coating composition according to claim 1, wherein the micro-beads have an average particle size in a range from 20 μm to 50 μm.

13. The release coating composition according to claim 1, wherein the ratio of the amount of the micro-beads to the amount of polymer binder (v/v) is in the range of 1:0.1 to 1:60.

14. The release coating composition according to claim 1, wherein the ratio of the amount of the micro-beads to the amount of polymer binder (v/v) is in the range of 1:0.2 to 1:20.

15. The release coating composition according to claim 1, wherein the coating composition is free of silicone and fluorine.

16. The release coating composition according to claim 1, wherein the coating composition further comprises at least one additive.

17. The release coating composition according to claim 16, wherein the additive is at least one selected from the group consisting of deforming agents, rheology adjusting agents, dispersing agents, pH adjusting agents, antimicrobial agents, anti-static agents, cross-linkers, and combinations thereof.

18. A release liner comprising:
a substrate having a first side and a second side; and
a release coating composition of claim 1 coated on at least one of the first side and the second side of the substrate.

19. The release liner according to claim 18, wherein the substrate is at least one selected from the group consisting of paper and polymeric film.

20. A laminate comprising:
a facestock having a first side and a second side;
a pressure sensitive adhesive disposed on the first side of the facestock;
optionally, a release liner at least partially covering the adhesive disposed on the facestock; and
a release coating composition of claim 1 coated on at least one of the second side of the facestock or the adhesive covering side of the release liner.

21. The laminate according to claim 20:
wherein a release liner is present covering the adhesive; and
wherein a release coating composition of claim 8 is coated on the adhesive covering side of the release liner.

22. A laminate according to claim 20:
wherein a release coating composition of claim 1 is coated on the second side of the facestock.

23. The laminate according to claim 20, wherein the facestock is a monolayer material or a multilayer material.

24. The laminate according to claim 20, wherein the facestock comprises at least one material selected from the group consisting of paper, polymeric film, and combinations thereof.

25. The laminate according to claim 24, wherein the polymeric film is at least one film selected from the group consisting of polyester film, polyolefin film, polyethylene terephthalate film, polyethylene film, polypropylene film, polyvinyl chloride film, polyurethane film, poly-acrylate film, acrylate-urethane copolymer film, metalized film, primer coated polymeric film, and combinations thereof.

26. The laminate according to claim 24, wherein the paper is at least one paper selected from the group consisting of craft paper, mid gloss paper, vellum paper, maplitho paper, chromo paper, semi-gloss paper, high-gloss paper, foils, metallized paper, hemp paper, glassine paper, primer coated paper, and combinations thereof.

27. The laminate according to claim 20, wherein the pressure sensitive adhesive is at least one adhesive selected from the group consisting of solvent based adhesive, emulsion based adhesive, hot-melt adhesive, heat activated adhesive, semi-structural adhesive, structural adhesive, and combinations thereof.

28. The release liner according to claim 20, wherein the release coating composition has a release force in a range from 1 g/2 inch to 1000 g/2 inch.

29. The release liner according to claim 18 is recyclable.

30. The release liner according to claim 18 is printable.

31. The laminate according to claim 20 is printable.
